(19) United States
(12) Patent Application Publication
(10) Pub. No.: US 2011/0251727 A1
(43) Pub. Date: Oct. 13, 2011

(54) MOTOR-DRIVEN WORKING DEVICE

(75) Inventors: Thilo Koeder, Gerlingen (DE); Joachim Platzer, Remseck-Hochberg (DE); Ulli Hoffmann, Niefern-Oeschelbronn (DE); Jan Koegel, Mount Prospect, IL (US)

(73) Assignee: ROBERT BOSCH GMBH, Stuttgart (DE)

(21) Appl. No.: 13/001,911

(22) PCT Filed: May 5, 2009
(86) PCT No.: PCT/EP2009/055390

§ 371 Date: Mar. 16, 2011

(30) Foreign Application Priority Data
Jul. 2, 2008 (DE) 10 2008 040 064.5

(51) Int. Cl. G05B 19/19

(52) U.S. Cl. 700/279

(57) ABSTRACT

The invention relates to a motor-driven working device in the form of a machine tool (1) or a working apparatus, for which a semi-autonomous working operation is made possible by means of an auxiliary device (50). In said semi-autonomous working operation, the user must only carry out the rough alignment of the working device on a working line (27). The necessary guidance of the working means (48) of the working device on the working line (27) is provided by an auxiliary device (50).

The invention relates to a motor-driven working device, in particular in the form of an electrically operated machine tool or an electrically operated working apparatus, according to the preamble of claim 1.

### TECHNICAL FIELD

Working devices of the aforementioned kind in the form of saws are occasionally operated in practice with auxiliary devices, via which the user is supported in aligning the working device to the working line to be followed on the side of the material to be worked on. This occurs with optical as well as mechanical means.

### SUMMARY

The aim underlying the invention is to expand the use of such auxiliary devices to other working devices as well as to make such working devices more flexible in their usages through the use of such auxiliary devices.

This is achieved by using such auxiliary devices with working devices, which are configured as machine tools in the form of milling machines, rodents, tackers, shears or the like. That is to say said working devices are configured as machine tools in which a prioritization of a direction of work is not contingent upon the form of the working means. Furthermore, said aim is achieved by using said auxiliary devices with working apparatuses, in which such machine tools are, for example, integrated, such as stationary milling machines, or with working apparatuses like metering apparatuses for applying adhesive beads or sealing seams, with welding robots, with cutting tools, such as laser cutters or water jet apparatuses or with apparatuses for local plasma pretreatment. In the case of such working apparatuses, the working means are in fact frequently configured with regard to the respective conditions of use. As a rule, said working means do not, however, for their part specify any direction of work as a result of their design as is, for instance, the case with saw blades.

The auxiliary device comprises a sensor system, which is aligned on a detection surface that results from the position of the sensor system with respect to the working means. A working line to be followed by said working means is detected on the side of the material being worked on via the sensor system. Said auxiliary device furthermore includes a signal processing unit for the characteristic data acquired by said sensor system, said characteristic data being processed in a control and actuating unit and being used for the alignment of the working device and or the working means on the working line.

A working device configured in this manner is basically flexible with regard to the work application and therefore to be employed as a hand-guided, hand-held or mechanically guided working device. In the latter case, the working device is employed particularly with stationary apparatuses as well as with transportable table apparatuses.

Regardless of the function of auxiliary device, the sensor system can be a structurally integrated component of the working device or also be disposed separately from said device in order to facilitate work along a predetermined working line. In this way, the respective detection surface and thereby the working line running therethrough can be most effectively detected. The visualization of the operation, which may be required, for example, by means of corresponding informational graphics, preferably takes place however in each case linked to the working device in a field of view for the user that is associated with the said device. In accordance with the appropriate degree of visualization, the respective working means is if need be correspondingly aligned to the working device. This alignment process applies, for example, to the case of a laser cutter, whereby the optics are correspondingly aligned, or to that of a welding robot, whereby the weld head is correspondingly adjusted.

If work is done with auxiliary devices, which as a visualization aid only provide information to the user about how he is to guide a respective working device so that the working means in each case operates along the predefined working line, the user then for the most part has to correspondingly guide the working device.

If the auxiliary device is configured and used according to the idea of the invention to the effect that the working means shifts relative to the working device held by the user and is aligned on the working line, the user performs essentially only the function of supporting said working device and while oriented on the direction of work of shifting, in particular of displacing, said working device in said direction of work. A semi-autonomous operating method is then in effect.

Depending upon the configuration and function of the working means, not only an alignment of said working means on the working line is possible but if need be also an adjustment which changes the operating method, thus, for example, changing the cross-sectional area of the outlet of an application nozzle or the like.

In the case of saws in their different embodiments and applications, as, for example, in the form of hacksaws or band saws as under-table or above-table apparatuses or as scroll saws, the working means is in each case an element which determines the direction of work on account of its flattened form and its sawing plane, which extends in the direction of work and therefore in the sawing direction. The alignment on the working line is then carried out by rotating the saw blade. In accordance with the respective angle of rotation, the forward motion in the sawing direction takes place along the working line. The operator in supporting the working device complies with this input requirement.

Working means, which themselves do not work in a directionally oriented fashion, like, for example, in the case of milling machines having milling cutters working with rotational removal motion, cannot determine the respective direction of work but have to in turn be guided with respect to the working device such that they follow a respective working line if on the part of the user the working device is only—roughly oriented to the direction of work specified by the working line—to be supported and moved.

In this context, provision is made according to the invention for the working devices, be they in the form of machine tools or working apparatuses, which work with such working means, to provide the working means with an adjustability with respect to the working device which is transverse to the respective working line, wherein this adjustability can take place linearly or in a pivotable manner and wherein with regard to a pivotable arrangement of the working means with respect to the working device, pivotal positions are worthy of consideration for the straight-ahead direction of work, in which the straight line connecting the working means to the pivot axis extends in the straight-ahead direction of work and is at an angle thereto. Corresponding to the angular position resulting with respect to the straight-ahead working position, larger or smaller pivot paths in a transverse direction result about the respective zero position with respect to the respective pivot angle, whereby the precision of the guidance along the working line can be influenced particularly since the respective lateral forces on the part of the user have to be absorbed in a supporting manner.

In the case of working apparatuses like welding robots, apparatuses for plasma pretreatment or also in the case of metering apparatuses for applying adhesive beads or sealing seams, the adaptation to the respective working line by the transverse movement of the working means is at best combined with slight lateral forces so that in this regard a quick and precise correction is especially of importance.

Further details and features of the invention arise from the claims, the description and the drawings. The latter show:

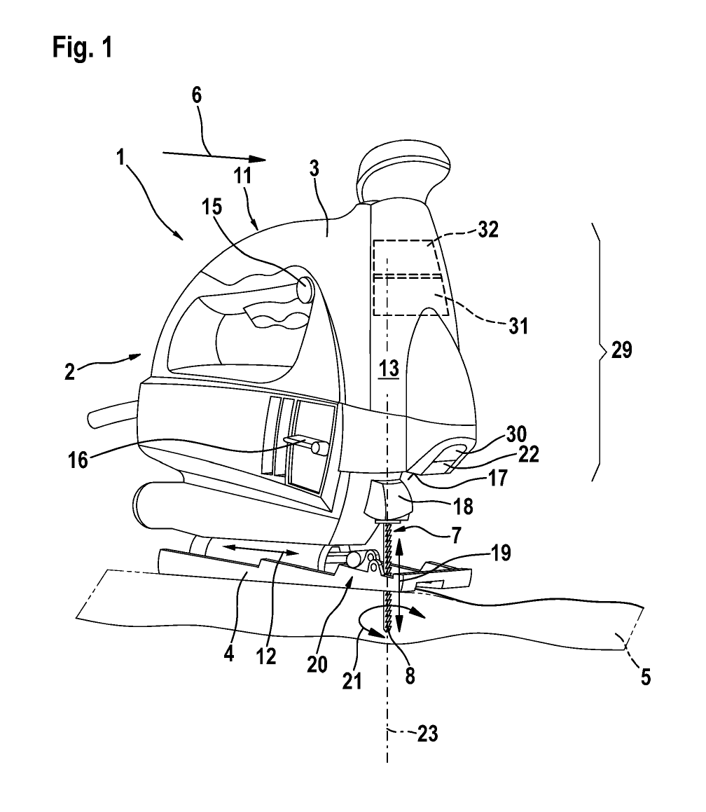

FIG. 1 a schematic depiction of a working device in the form of a jigsaw with an auxiliary device for alignment on a working line to be followed on a workpiece,

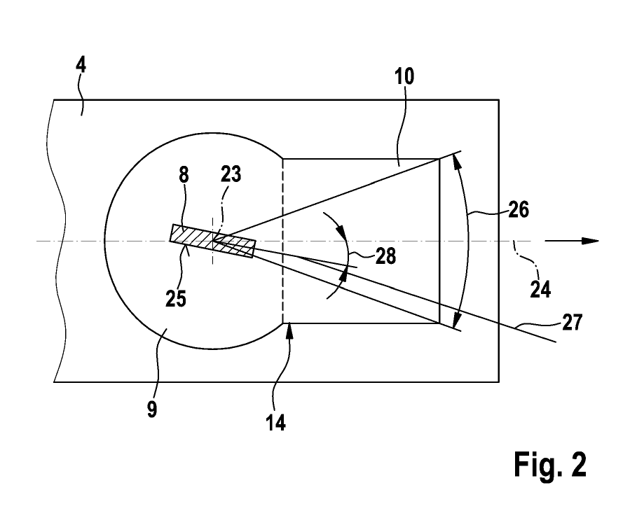

FIG. 2 a top view of the working area of the jigsaw on the base plate side schematized in the viewing direction of the workpiece,

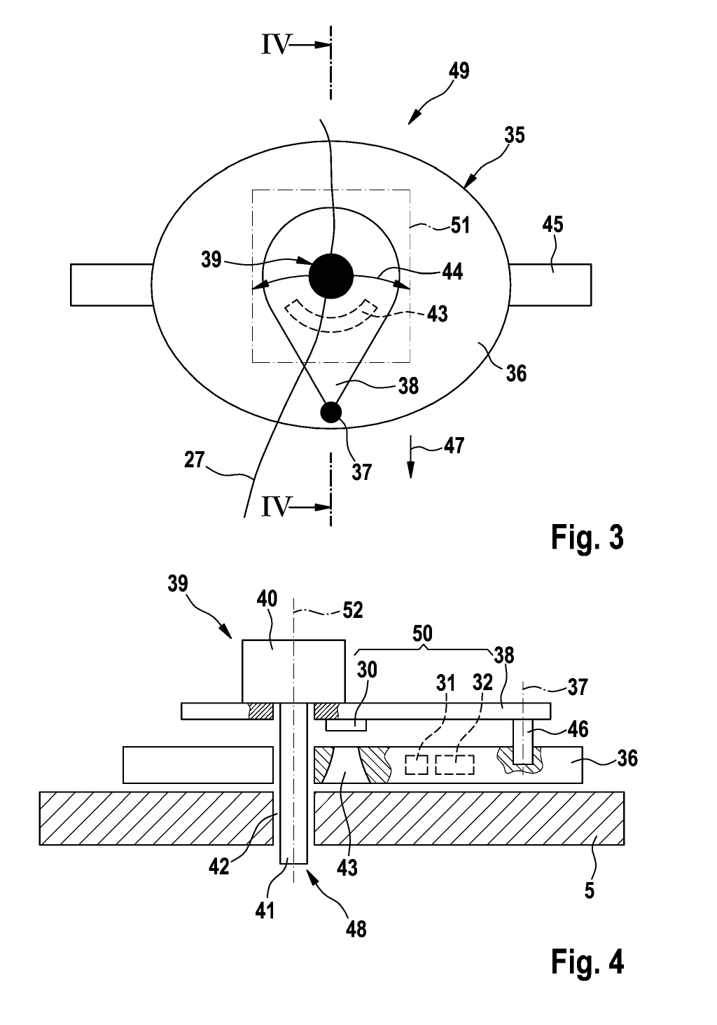

FIG. 3 top view of a schematized depiction of a hand held machine tool in the form of a milling machine positionally associated with a working line to be followed on the side of a workpiece, and

FIG. 4 partially sectional lateral view of an intensively schematized depiction of the working device, which is configured as a milling machine, according to FIG. 3.

A machine tool 1 is depicted in FIG. 1 as an example of a motor-driven working device. Said machine tool 1 is configured as a jigsaw 2, which is supported on a workpiece 5 by a base plate 4.

The jigsaw 2 has a housing 3 and is provided with its working means 7 in its forward region with respect to the direction of work 6. Said working means 7 is formed by a saw blade 7, which is reciprocally driven in the direction of the arrow 19, is held in a sawblade holder 18 and the reciprocating drive thereof is disposed in the region of the housing 3 lying thereabove.

For reciprocating drive in the direction of the arrow 19, the saw blade 8 is additionally to be driven via an actuator 20 in an oscillating manner in the direction of the arrow 12. Furthermore, the saw blade is rotatable about its axis of rotation which extends in stroke direction as is indicated by arrow 21. Different operating modes thereby result for said jigsaw 2, namely the normal working operation, wherein said jigsaw 2 works in the straight-ahead direction of work and the saw blade 8 extends with its flat sides 25 parallel to the longitudinal axis 24 of said jigsaw 2 and thereby along the longitudinal axis 24 of the corresponding sawing direction. A further working operation is the oscillating stroke operation, wherein said jigsaw 2 when shifted to the reciprocating drive is driven in a pendulum direction (arrow 12) via the actuator 20. As a third operating mode, the so-called scrolling mode is indicated by the arrow 21, wherein said saw blade 8 works in rotational positions displaced around its axis of rotation 23 with respect to the straight-ahead direction of work along the longitudinal axis 24 and can be adjusted to said rotational positions via an actuator, which is not depicted but only implied in FIG. 1. The setting of the respective working operation takes place via a switching device 16, which like a switching arrangement 15 is provided on the housing 3, which has an operating handle, which can be accessed on the user side.

FIG. 2 illustrates how the saw blade 8 penetrates the base plate 4 in the region of a recess 14, said recess 14 around said saw blade 8 defining a working area 9, which in the sawing direction transitions into a field of view which serves as a detection surface 10. The rotational angle range, across which said saw blade 8 can be moved around its axis of rotation 23, is indicated by the arrow 26.

FIG. 1 makes it clear that the visibility of the respective working area on the workpiece 5 is partially restricted. That is why an illumination assembly 22 is provided below the front face region 13 in the region of the backwardly oriented surface 17, which covers the saw blade holder 18.

Furthermore, a sensor system 30 which is formed preferably by a camera and is aligned on the field of view as a detection surface 10, is disposed in this region; thus enabling conditions detected in the region of the field of view to be visualized by the user independently of the immediate observation of the working area. A special information display for said user could, for example, be provided for this purpose or also for other purposes such as, e.g., for the documentation of work results. An arithmetic and logic unit 31, which is schematically indicated, can among other things meet this end.

An arithmetic and logic unit 31 of this kind as well as a control and/or actuating unit 32, which is likewise only schematically indicated, is particularly provided for the purpose of supporting the user in the immediate handling of the jigsaw 2. This support particularly includes the tracking of working lines specified by markings or the like on the workpiece side; hence, for example, of a working line 27 according to FIG. 2, which extends within the rotational angle range for the saw blade 8 as illustrated by the arrow 26, and on which said saw blade 8 is to be aligned in its sawing direction. The working line 27 thereby runs approximately through the axis of rotation 23 of the saw blade 8.

A semi-autonomous working operation for the jigsaw 2 as a hand-held working device is made possible by means of such an auxiliary device 29, which is symbolized by the sensor system 30 and the subordinate processing and actuating devices are illustrated by the arithmetic and logic unit 31 and the control and actuating unit 32. In said semi-autonomous working operation, the angle of rotation 28 of said jigsaw 2 is set in accordance with the respectively detected working line 27 such that a sawing direction which follows said working line 27 results and the user has only to support said jigsaw 2 with regard to this direction of work. Essentially the user must therefore only absorb the restoring forces (cutting forces) resulting from the sawing operation. The saw blade 8 thus specifies a working direction corresponding to the respective saw blade plane and ultimately determines the direction of work in accordance with the respective angle-of-rotation position which is aligned on a predetermined working line 27.

If hacksaws of this type are used as table saws having a saw blade lying above or below the table surface, a corresponding working method is thus provided when the working position of the jigsaw with regard to the respective table is specified and when the workpiece is supported by the user in alignment on the angle-of-rotation position of the saw blade corresponding to the working line to be followed. Substantially corresponding relationships are provided with respect to band saws because also in this instance a flat support between the respective material to be worked on, i.e. the respective workpiece, and the saw blade is provided; thus requiring a mutual alignment in the region of the saw blade.

Whereas in the exemplary embodiment according to FIGS. 1 and 2, provision is made for a working means 7 in the form of a saw blade 8, which on account of its form works in a directionally orientated manner and which is aligned on the respective working line 27 by rotation about an axis 23 that is fixed in its position with respect to the device, the alignment occurs in the exemplary embodiment according to FIGS. 3 and 4 because of the fact that the working means 48, which in its form is non-directional with respect to the direction of work, is displaced, in particular pivoted, in a transverse direction to the working line 27 in relation to the receiving device.

Basically this is also possible in connection with solutions, which according to FIGS. 1 and 2 provide for a rotatability of the working means for alignment on the working line and the axis of rotation of said working means. A coordination of the rotational and pivoting movements is then however required.

It is preferred for the working means 48 to be transversely displaceable to the device, in particular a pivotability transverse to the working line is especially advantageous for working devices, which are neutral in shape with regard to their alignment on the working line, thus particularly rotary working means and tools as, for example, milling cutters 41.

As seen in a top view, the exemplary embodiment according to FIGS. 3 and 4 shows a hand-held milling machine 35 as a working device in the form of a machine tool, wherein according to FIG. 4 said milling machine 35 has a base plate 36 which is configured if need be in the form of a housing and can, for example, analogously to FIG. 1 accommodate the arithmetic and logic unit 31 and the control and/or actuating unit 32 and to which a pivot arm 38, which carries a milling head 39, is hingedly connected so as to be pivotable about an axis 37. The milling head 39 comprises the electric drive motor 40 and the milling cutter 41 as the working means 48, which is configured in this case according to the manner of an end mill. Said milling cutter 41 penetrates the base plate 36 and cuts through the workpiece 5 on the working line 27 or at least engages said workpiece 5 so that in the milled cut 42 which follows said working line 27 a bilateral support is given for said milling cutter 41 on its working position, which thereby at least approximately describes a position of equilibrium.

FIG. 4 further illustrates that a sensor system 30, which especially comprises a camera, is provided on the pivot arm 38 and also if applicable on the milling head 39. The sensor system 30 lies in the pivoting region around the axis 37 so as to overlap a recess 43 in the base plate 36; thus enabling the working line 27, which the milling cutter 41 as the working means is supposed to follow, to be detected via the sensor system 30 in the region of the detection surface 51 which is indicated by the dotdashed line. Any deviations from said working line 27 as a result of repositioning the pivot arm 38 with the milling head 39 disposed thereupon, as indicated via the arrow 44, are converted into corresponding actuating commands via the arithmetic and logic unit 31 and the control and/or actuating unit 32. Via said actuating commands, said milling head 39 is then displaced with respect to the base plate 36, which for its part forms the manipulating part of the milling machine 35 and is guided by the user via the indicated handles 45. The operation in the exemplary embodiment according to FIGS. 3 and 4 is therefore performed with an auxiliary device as is the case in FIGS. 1 and 2.

The depiction according to FIG. 4 assumes that the pivot arm 38 is moved about the pivoting axis 37 via an actuating drive disposed in the base plate 36 and a shaft connection 46 which is concentric to said axis 37. The pivot arm 38 can, however, also in principle be moved, for example, by an actuator, which extends between said pivot arm 38 and said base plate 36.

Because the milling cutter 41 provided as the working means in the exemplary embodiment bilaterally engages the workpiece in the milled cut so as to facilitate the removal of material, the user in following the working line 27 has substantially only to generate the forces corresponding to the required feed forces.

If the sensor system 30 having the subordinate arithmetic and logic unit 31 as well as the control and/or actuating unit 32 is used for aligning the working device 35 on the working line 27, a semi-autonomous operation is possible according to the invention in the case of such a solution, wherein the user has only to generate the required feed forces and to support the milling machine 35 in its position with respect to said working line 27 in a stabilizing manner. This results from the fact that merely the direction of work moves accordingly in connection with corresponding, relatively small path corrections oriented to said working line 27.

In principle, a working device like the milling machine 35 depicted in FIGS. 3 and 4 is not bound to a direction of work as a result of the design of its working means 48. The use of the milling machine 35 when disposed with respect to the direction of work 47 as depicted in FIG. 3 has proven to be effective. In so doing, the pivoting axis 37 lies in front of the milling head 39 in the direction of work 47, and the milling cutter 41 is thereby dragged in a self-stabilizing manner.

Within the scope of the invention, with regard to the straight-ahead direction of work, the pivot axis 37 and the axis 52 of the milling cutter 41, which serves as the working means, can lie on a straight line, which extends in the straight-ahead direction of work, so that symmetrical supporting forces result in said straight-ahead direction of work. Within the scope of the invention, a connecting straight line, which runs at an acute angle to the straight-ahead direction of work, between the axes 37 and 48 can, however, also be advantageous when adapting to special working conditions.

In the previous exemplary embodiments, material-processing and material-removing tools are in each case provided as the working means. Within the scope of the invention, particularly a configuration according to FIGS. 3 and 4 can, however, also be implemented with working means, which, particularly as parts of working apparatuses, serve to process material. Said working means can, for example, be configured as material discharge nozzles for applying sealing seams or adhesive beads. In so doing, the sealing seam is, for example, detected as the working line by means of sensors and the discharge nozzle is aligned on the sealing seam such that a semi-autonomous operation results which is analogous to that in FIGS. 3 and 4. In addition, the option exists thereby, in accordance with the detected seam values, for example the seam width, to exert influence over the material discharge, be it by adjusting the nozzle or by changes in the delivery rate.

The sensor system according to the invention can thereby be directly complemented and as the case may be by ulterior auxiliary means, in particular ulterior sensors, and can also be used to detect the respective feed rate; thus enabling influence to be exerted on the mentioned parameters also while taking into account the feed rate.

If the solution according to the invention is used with welding robots, stationary cutting tools or apparatuses for local plasma pretreatment, their working means can be controlled according to the principle, which is explained with the aid of FIGS. 1 and 4, when following the respective working line 27 as a specified path. The impact between two parts can hereby, for example, be sufficient to be detected as the working line for the welding connection so that the contour to be followed does not have to be separately specified as said working line. Corresponding conditions can also occur when applying adhesive beads. A semi-autonomous operation is thereby also possible for such apparatuses, whereby the demands on the respective user are reduced.

1. Motor-driven working device, particularly an electrically operated machine tool or an electrically operated working apparatus, having a driven and/or displaceable working means and having an auxiliary device, which supports the user in the guidance of the working device when following a predetermined working line, thereby characterized in that said working device is provided with a working means, which is guided so as to follow the working line during a non-directional operation and in that the auxiliary device is provided with a sensor system for detecting said working line specified for the working means, the sensor system being thereby aligned on a detection surface, which results from the position of said sensor system with respect to said working means, with an arithmetic and logic unit for the characteristic data of said working line detected via the sensor system and with a control and actuating unit for processing said characteristic data, via which said working means is guided such that it is aligned to said working line.

2. Working device according to claim 1, characterized by the design thereof as a machine tool, particularly in the form of a milling machine, a rodent, a shears or a tacker, or by the design thereof as a working apparatus, particularly in the form of a metering apparatus for applying adhesive beads or sealing seams, of a welding robot, of a cutting tool, such as working as a laser cutter or water jet apparatus, or by the design thereof as an apparatus for local plasma pretreatment, wherein the working device in each case is configured with a non-directionally operating working means.

3. Working device according to claim 1, wherein the working device is configured to be hand-held, hand-guided or mechanically guided, particularly as a working device which is secured to a table.

4. Working device according to claim 1, wherein the sensor system is a structurally integrated component of the working device.

5. Working device according to claim 1, wherein the sensor system is separately disposed as part of the working device.

6. Working device according to claim 1, wherein the working means can be displaced transversely to the working line on the device side and can be adjusted onto the working line.

7. Working device according to claim 6, wherein the working means is guided such that it can be displaced transversely to the working line.

8. Working device according to claim 6, wherein the working means is disposed so as to be pivotable transversely to the working line.

9. Working device according to claim 6, wherein the working means is formed by a rotary working tool, in particular a milling cutter, the axis of rotation of which lies offset to the pivoting axis.

10. Working device according to claim 6, wherein the working means is formed by a nozzle, a laser head or by working parts operating otherwise as emitting, suctioning, brushing or abradant parts.

11. Working device according to claim 1, wherein the working device has a supporting structure to be arranged in the region of the respective working line, in particular a base or foot plate.

12. Working device, particularly according to claim 1, which is configured as a milling machine, in particular as a hand-held milling machine, and has a milling cutter, thereby characterized in that the milling cutter is disposed such that it can be displaced transversely to the respective direction of work of the milling machine.

13. Working device according to claim 12, wherein the milling machine has a base plate, which is penetrated by the milling cutter and said milling cutter can be displaced transversely to the respective working position of the milling machine with respect to the base plate.

14. Working device according to claim 12, wherein the base plate forms the manipulating part of the milling machine.

15. Working device according to claim 12, wherein the milling cutter can be displaced with respect to the base place so as to be pivotally movable in the direction of extension of the same.

16. Working device according to claim 12, wherein the milling machine has a milling head comprising the drive of the milling cutter and is supported by the milling head via a pivot arm mounted on the base plate.

17. Working device according to claim 12, wherein the pivot arm is displaced via the auxiliary device in accordance with the course of the working line and is adjusted with the milling cutter to its working position with respect to the working line.
